(19) United States
(12) Patent Application Publication
(10) Pub. No.: US 2026/0320102 A1
(43) Pub. Date: Oct. 15, 2026

(54) SYSTEMS AND METHODS FOR DYNAMIC OUTCOME VARIABLE ESTIMATION VIA MACHINE-LEARNING-BASED FEATURE TRANSFORMATION

(71) Applicant: Canotera LTD, Haifa (IL)

(72) Inventors: David H. Silver, Poughkeepsie, NY (US); Tal Knafo, Haifa (IL)

(73) Assignee: Canotera LTD, Haifa (IL)

(21) Appl. No.: 19/444,287

(22) Filed: Jan. 9, 2026

Related U.S. Application Data
(60) Provisional application No. 63/744,471, filed on Jan. 13, 2025.

(51) Int. Cl. G06F 16/38; G06F 40/284

(52) U.S. Cl. CPC G06F 16/382; G06F 40/284

(57) ABSTRACT

A system and method for processing case-related electronic documents to generate an output file is presented. The method includes receiving a plurality of documents as electronic files; generating a structured matter data based on the received plurality of documents; generating a plurality of embeddings for at least a portion of the documents using a language model; constructing a heterogeneous knowledge graph, wherein the heterogeneous knowledge graph includes a plurality of nodes that represent the structured matter data and at least a subset of the plurality of nodes include an embedding among the plurality of embeddings as node features; generating a graph representation by performing message passing on the heterogeneous knowledge graph using a graph neural network, wherein the message passing updates the node features; generating an outcome prediction based on the graph representation; and generating the output file, which includes the outcome prediction, based on the received plurality of documents.

### CROSS REFERENCE TO RELATED APPLICATION

This application claims the benefit of U.S. Provisional Application No. 63/744,471, filed Jan. 13, 2025, the contents of which are hereby incorporated by reference.

### TECHNICAL FIELD

The present invention relates to the field of procedural data management systems and artificial intelligence, specifically to systems and methods for computational estimation of future event state variables using advanced mathematical models augmented with neural-symbolic architectures, federated learning, and LLM-assisted data processing.

### BACKGROUND

Legal and other case-related electronic documents are typically produced and stored in heterogeneous formats and repositories, and frequently contain dense unstructured narrative text, inconsistent citation styles, redactions, and metadata that is incomplete or non-canonical, which makes automated downstream analysis difficult at scale. Conventional approaches often rely on manual review, keyword search, or a series of rule sets. In addition, many existing systems provide outputs without reliable measures of uncertainty, without traceable linkage to supporting source passages, and without mechanisms for operating under confidentiality constraints across different processing environments. Accordingly, there remains a need for improved techniques for transforming case-related electronic documents into structured representations that preserve relational structure and support generation of a computable output file with results that are reproducible, calibrated, and explainable.

It would therefore be advantageous to provide a solution that would overcome the challenges noted above.

### SUMMARY

A summary of several example embodiments of the disclosure follows. This summary is provided for the convenience of the reader to provide a basic understanding of such embodiments and does not wholly define the breadth of the disclosure. This summary is not an extensive overview of all contemplated embodiments, and is intended to neither identify key or critical elements of all embodiments nor to delineate the scope of any or all aspects. Its sole purpose is to present some concepts of one or more embodiments in a simplified form as a prelude to the more detailed description that is presented later. For convenience, the term “some embodiments” or “certain embodiments” may be used herein to refer to a single embodiment or multiple embodiments of the disclosure.

A system of one or more computers can be configured to perform particular operations or actions by virtue of having software, firmware, hardware, or a combination of them installed on the system that, in operation, causes or cause the system to perform the actions. One or more computer programs can be configured to perform particular operations or actions by virtue of including instructions that, when executed by data processing apparatus, cause the apparatus to perform the actions.

In one general aspect, the method may include receiving a plurality of legal documents as electronic files, where the plurality of legal documents are associated with a legal matter. The method may also include generating a structured legal matter data based on the received plurality of legal documents. The method may furthermore include generating a plurality of embeddings for at least a portion of the legal documents using a language model; constructing a heterogeneous legal knowledge graph, where the heterogeneous legal knowledge graph includes a plurality of nodes and a plurality of edges, where the plurality of nodes represent the structured legal matter data and at least a subset of the plurality of nodes include an embedding among the plurality of embeddings as node features; generating a graph representation by performing message passing on the heterogeneous legal knowledge graph using a graph neural network, where the message passing updates the node features; generating an outcome prediction for the legal matter based on the graph representation; and generating the output file based on the received plurality of legal documents, the output file including the outcome prediction. Other embodiments of this aspect include corresponding computer systems, apparatus, and computer programs recorded on one or more computer storage devices, each configured to perform the actions of the methods.

Implementations may include one or more of the following features. The method may include: identifying temporal information in the received plurality of legal documents; identifying citations in the received plurality of legal documents; identifying parties in the received plurality of legal documents; standardizing the temporal information in the received plurality of legal documents to coordinated universal time; standardizing the citations based on a citation style; and standardizing the parties in the received legal documents based on party-role references; identifying an authority in the plurality of legal documents based on the citations; and constructing a citation graph, where the citation graph includes a plurality of citation nodes and a plurality of citation edges, where the authority is represented as a node among the plurality of citation nodes, the citations are represented as an edge among the plurality of edges, and the plurality of citation nodes are connected by the plurality of citation edges; identifying a plurality of text spans in the legal documents; tokenizing the text spans based on a domain vocabulary; and encoding the tokenized text spans using a transformer-based encoder; pooling the encoded tokenized text spans over the plurality of text spans based on mean-pooling; and projecting the pooled encoded tokenized text spans from a first dimension to a second dimension to generate the plurality of embeddings; identifying clauses of the legal documents; associating text spans to the clauses of the legal documents; encoding the associated text spans to generate clause-level embeddings; aggregating the clause-level embeddings; generating section-level embeddings based on the aggregated clause-level embeddings; aggregating the section-level embeddings; and generating document-level embeddings based on the aggregated section-level embeddings. The method where generating the outcome prediction includes applying a meta-learner to outputs of a plurality of base learners, where the plurality of base learners includes the graph neural network; calibrating a probability output associated with the outcome prediction using Platt scaling, where the output file further includes the probability output; modifying at least one structured attribute in the structured legal matter data; generating a second outcome prediction based on the modified structured attribute; and determining a counterfactual delta based on the outcome prediction and the second outcome prediction, where the output file further includes the counterfactual delta. Implementations of the described techniques may include hardware, a method or process, or a computer tangible medium.

In one general aspect, non-transitory computer-readable medium may include one or more instructions that, when executed by one or more processing circuitries of a device, cause the device to: receive a plurality of legal documents as electronic files, where the plurality of legal documents are associated with a legal matter; generate a structured legal matter data based on the received plurality of legal documents; generate a plurality of embeddings for at least a portion of the legal documents using a language model; construct a heterogeneous legal knowledge graph, where the heterogeneous legal knowledge graph includes a plurality of nodes and a plurality of edges, where the plurality of nodes represent the structured legal matter data and at least a subset of the plurality of nodes include an embedding among the plurality of embeddings as node features; generate a graph representation by performing message passing on the heterogeneous legal knowledge graph using a graph neural network, where the message passing updates the node features; generate an outcome prediction for the legal matter based on the graph representation; and generate the output file based on the received plurality of legal documents, the output file including the outcome prediction. Other embodiments of this aspect include corresponding computer systems, apparatus, and computer programs recorded on one or more computer storage devices, each configured to perform the actions of the methods.

In one general aspect, the system may include a processing circuitry. The system may also include a memory, the memory containing instructions that, when executed by the processing circuitry, configure the system to receive a plurality of legal documents as electronic files, where the plurality of legal documents are associated with a legal matter; generate a structured legal matter data based on the received plurality of legal documents; generate a plurality of embeddings for at least a portion of the legal documents using a language model; construct a heterogeneous legal knowledge graph, where the heterogeneous legal knowledge graph includes a plurality of nodes and a plurality of edges, where the plurality of nodes represent the structured legal matter data and at least a subset of the plurality of nodes include an embedding among the plurality of embeddings as node features; generate a graph representation by performing message passing on the heterogeneous legal knowledge graph using a graph neural network, where the message passing updates the node features; an outcome prediction for the legal matter based on the graph representation; generate the output file based on the received plurality of legal documents, the output file including the outcome prediction. Other embodiments of this aspect include corresponding computer systems, apparatus, and computer programs recorded on one or more computer storage devices, each configured to perform the actions of the methods.

Implementations may include one or more of the following features. The system where the memory contains further instructions which when executed by the processing circuitry further configure the system to: identify temporal information in the received plurality of legal documents; identify citations in the received plurality of legal documents; identify parties in the received plurality of legal documents; standardize the temporal information in the received plurality of legal documents to coordinated universal time; standardize the citations based on a citation style; and standardize the parties in the received legal documents based on party-role references.

The system where the memory contains further instructions which when executed by the processing circuitry further configure the system to: identify an authority in the plurality of legal documents based on the citations; and construct a citation graph, where the citation graph includes a plurality of citation nodes and a plurality of citation edges, where the authority is represented as a node among the plurality of citation nodes, the citations are represented as an edge among the plurality of edges, and the plurality of citation nodes are connected by the plurality of citation edges.

The system where the memory contains further instructions which when executed by the processing circuitry further configure the system to: identify a plurality of text spans in the legal documents; tokenize the text spans based on a domain vocabulary; and encode the tokenized text spans using a transformer-based encoder.

The system where the memory contains further instructions which when executed by the processing circuitry further configure the system to: pool the encoded tokenized text spans over the plurality of text spans based on mean-pooling; and project the pooled encoded tokenized text spans from a first dimension to a second dimension to generate the plurality of embeddings.

The system where the memory contains further instructions which when executed by the processing circuitry further configure the system to: identify clauses of the legal documents; associate text spans to the clauses of the legal documents; encode the associated text spans to generate clause-level embeddings; aggregate the clause-level embeddings; generate section-level embeddings based on the aggregated clause-level embeddings; aggregate the section-level embeddings; and generate document-level embeddings based on the aggregated section-level embeddings.

The system where generating the outcome prediction includes applying a meta-learner to outputs of a plurality of base learners, the plurality of base learners includes the graph neural network.

The system where the memory contains further instructions which when executed by the processing circuitry further configure the system to: calibrate a probability output associated with the outcome prediction using Platt scaling, where the output file further includes the probability output.

The system where the memory contains further instructions which when executed by the processing circuitry further configure the system to: modify at least one structured attribute in the structured legal matter data; generate a second outcome prediction based on the modified structured attribute; and determine a counterfactual delta based on the outcome prediction and the second outcome prediction, where the output file further includes the counterfactual delta. Implementations of the described techniques may include hardware, a method or process, or a computer tangible medium.

### BRIEF DESCRIPTION OF THE DRAWINGS

The subject matter disclosed herein is particularly pointed out and distinctly claimed in the claims at the conclusion of the specification. The foregoing and other objects, features, and advantages of the disclosed embodiments will be apparent from the following detailed description taken in conjunction with the accompanying drawings.

FIG. 1 is an example system diagram of a computing environment, utilized to describe an embodiment.

FIG. 2 is an example of a bilateral text filter pipeline, implemented in accordance with an embodiment.

FIG. 3 is an example diagram of a federated learning topology, implemented in accordance with an embodiment.

FIG. 4 is an example flowchart of a method for processing case-related electronic documents to generate an output file, implemented in accordance with an embodiment.

FIG. 5 is an example processing pipeline, implemented in accordance with an embodiment.

FIG. 6 is an example schematic diagram of a data ingestion subsystem 110 according to an embodiment.

### DETAILED DESCRIPTION

It is important to note that the embodiments disclosed herein are only examples of the many advantageous uses of the innovative teachings herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, like numerals refer to like parts through several views.

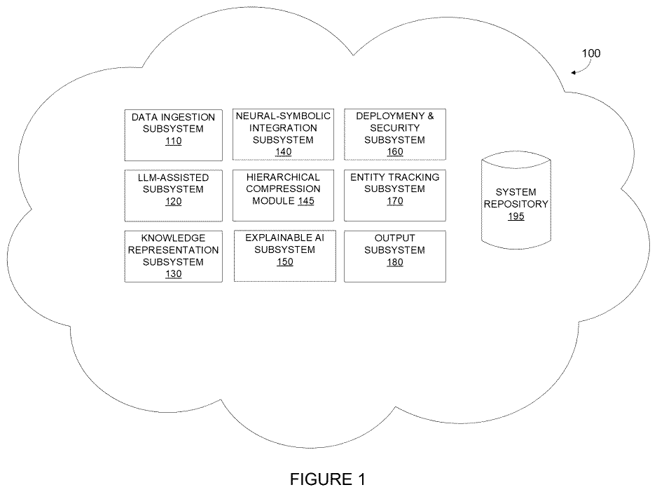

FIG. 1 is an example system diagram of a computing environment, utilized to describe an embodiment.

In some embodiments, the analytics system 100 includes a data ingestion subsystem 110, a LLM-assisted subsystem 120, a knowledge representation subsystem 130, a neural-symbolic integration subsystem 140, a hierarchical compression module 145, an explainable artificial intelligence (AI) subsystem 150, a security and operation subsystem 160, an entity tracking subsystem 170, an output subsystem 180, a system repository 195, various combinations thereof, and the like.

In an embodiment, the data ingestion subsystem 110 is configured to receive legal documents and associated matter metadata. In some embodiments, the legal documents include pleadings, motions, orders, docket sheets, hearing transcripts, statutory materials, regulatory materials, a combination thereof and the like.

In some embodiments, the matter metadata includes court, judge, case type, procedural posture, a combination thereof and the like.

In some embodiments, the data ingestion subsystem 110 is configured to receive the legal documents from heterogeneous sources including electronic court filing systems, document repositories, file uploads, partner data feeds, a combination thereof and the like.

In some embodiments, the legal documents are provided in heterogeneous file formats including PDF, XML, and ECF/CMECF entries, a combination thereof and the like.

In some embodiments, the data ingestion subsystem 110 is configured to normalize the legal documents. In some embodiments, normalizing the legal documents includes optical character recognition, deduplication, MIME-type detection, layout-aware paragraph segmentation, citation normalization, canonicalization, date normalization, a combination thereof and the like.

In some embodiments, the data ingestion subsystem 110 is configured to perform boundary emission.

In some embodiments, boundary emission includes identifying and recording canonical text spans corresponding to contiguous sequences of machine-readable text in the normalized legal documents.

In some embodiments, boundary emission further includes identifying and recording section boundaries delimiting the canonical text spans.

In some embodiments, the data ingestion subsystem 110 is configured to perform optical character recognition to extract machine-readable text from the legal documents.

In some embodiments, the data ingestion subsystem 110 is configured to perform deduplication to remove duplicate legal documents.

In some embodiments, the data ingestion subsystem 110 is configured to perform citation normalization on citation text appearing in the machine-readable text extracted from the legal documents.

In some embodiments, citation normalization includes identifying a citation text spans in the machine-readable text and applying the citation canonicalization based on a citation style. In at least one embodiment, the citation style is Bluebook-style citation. In at least one embodiment, the citation style is based on a user input. In at least one embodiment, the citation style is a predetermined citation style. For example, when applying Bluebook-style citation the data ingestion subsystem 110 is configured to perform pattern matching on the text spans to identify the citation text spans. In at least one embodiment, the pattern matching includes applying one or more predefined citation patterns consistent with the citation style.

In some embodiments, the user input is received via a client device. In some embodiments, the client device provides a graphical-user interface, a dashboard, a combination thereof and the like, that enables receipt of the user input.

In some embodiments, the data ingestion subsystem 110 is configured to perform canonicalization on timestamps and party-role references, a combination thereof and the like, appearing in the machine-readable text and the matter metadata. “In some embodiments, party-role references include references identifying a procedural role of a party in the legal matter, including Plaintiff, Defendant, Petitioner, Respondent, Appellant, Appellee, Movant, and Non-movant, a combination thereof and the like. In some embodiments, canonicalization includes mapping variant role labels appearing in the legal documents and/or matter metadata to a canonical role label set and associating the canonical role labels with corresponding party identifiers for the legal matter.

In some embodiments, canonicalization includes identifying temporal information in the received legal documents and standardizing the temporal information based on Coordinated Universal Time. For example, canonicalization includes standardizing timestamps to Coordinated Universal Time.

In some embodiments, the data ingestion subsystem 110 is configured to perform date normalization on dates appearing in the machine-readable text and the matter metadata. In some embodiments, date normalization includes converting the dates to ISO-8601 format or another standardized date format, a combination thereof and the like.

In some embodiments, the data ingestion subsystem 110 is configured to associate canonicalized representations with cryptographic audit logs. In some embodiments, the cryptographic audit logs include append-only records hash-chained using a cryptographic hash function including SHA-256, a combination thereof and the like. In some embodiments, the cryptographic audit logs are stored with per-matter access compartments enforced via attribute-based access control. In some embodiments, the cryptographic audit logs are stored in the system repository 195.

In some embodiments, the data ingestion subsystem 110 is configured to process masked entities appearing in the machine-readable text of the normalized legal documents to preserve semantic utility for downstream extraction and embedding.

In some embodiments, the data ingestion subsystem 110 is configured to replace masked entity spans with typed surrogates. In some embodiments, the typed surrogates include strings of the form ENT_{[k,type]}. In some embodiments, k includes a per-document counter and type includes one or more of PERSON, ORG, and AMOUNT.

In some embodiments, the data ingestion subsystem 110 is configured to preserve context windows including up to a threshold number of tokens before and after each masked entity span to maintain semantic coherence. In at least one embodiment, the threshold number is fifty (e.g., ±50).

In some embodiments, the data ingestion subsystem 110 is configured to store the typed surrogates, preserved context windows, a combination thereof and the like, in association with the normalized legal documents such that an entity tracking subsystem 170 subsequently resolves cross-document identity among masked entities. In some embodiments, typed surrogates, preserved context windows, associated normalized legal documents, a combination thereof and the like are stored in the system repository 195.

In some embodiments, a text encoder is configured to treat the typed surrogates as special tokens.

In these embodiments, the text encoder is configured to generate learnable embeddings for the special tokens. In some embodiments, the learnable embeddings are initialized to type-specific priors.

In an embodiment, an LLM-assisted subsystem 120 is configured to extract structured case signals from the normalized legal documents. In some embodiments, the structured case signals include named entities, events, procedural milestones, argumentative units, citations, a combination thereof and the like.

In some embodiments, one or more language models are accessed via API. In some embodiments, the one or more language models include specialized small language models fine-tuned on legal corpora, open-source models deployed on-premise within an institutional network boundary, a combination thereof and the like.

In some embodiments, the LLM-assisted subsystem 120 is configured to dynamically select among the one or more language models and among one or more model access modes, a combination thereof and the like, based on one or more criteria.

In some embodiments, the one or more model access modes include API-accessed execution and on-premise execution within an institutional network boundary.

In some embodiments, the one or more criteria include a task complexity score, a matter confidentiality level, a target latency threshold, a cost budget, a combination thereof and the like.

In some embodiments, the LLM-assisted subsystem 120 is configured to select among one or more language models and one or more model access modes based on one or more criteria including the matter confidentiality level. In some embodiments, the matter confidentiality level is determined based on the legal documents. In these embodiments, the model routing module is configured to route higher-sensitivity matters to on-premise models and to route lower-sensitivity matters to API-accessed models. In some embodiments, routing higher-sensitivity matters to on-premise models prevents transmission of confidential matter data to external APIs, a combination thereof and the like.

In some embodiments, the matter confidentiality level is determined based on a user-specified matter tag received via a client device. In some embodiments, the matter confidentiality level is determined based on one or more rules applied to the normalized legal documents, including detecting one or more confidentiality indicators such as sealed-filing designations, redaction markers, privilege legends, protective-order references, a combination thereof and the like.

In some embodiments, the matter confidentiality level is based on user input.

In some embodiments, the LLM-assisted subsystem 120 is configured to route higher-sensitivity matters (i.e., the matter confidentiality is above a predetermined threshold) to on-premise models and to route lower-sensitivity matters to API-accessed models (i.e., the matter confidentiality is below the predetermined threshold or a second predetermined threshold).

In some embodiments, the LLM-assisted subsystem 120 is configured to route extraction subtasks to specialized small language models.

In some embodiments, the one or more language models receive a non-generative prompt and the normalized legal documents as inputs.

In some embodiments, the one or more language models extract named entities over machine-readable text in the normalized legal documents, including parties, plaintiffs, claims, statutes, a combination thereof and the like.

In some embodiments, the one or more language models extract events over machine-readable text in the normalized legal documents. In some embodiments, the extracted events include procedural milestones including causes of action, motions, dispositions, relief sought, a combination thereof and the like.

In some embodiments, the LLM-assisted subsystem 120 is configured to segment the normalized legal documents into argumentative units. In some embodiments, the argumentative units include claims, premises, rebuttals, standards of review, requested relief, a combination thereof and the like.

For example, a filing is segmented into claims, premises, rebuttals, standards of review, requested relief, a combination thereof and the like.

In some embodiments, the LLM-assisted subsystem 120 is configured to construct a directed multigraph based on structured case signals. In some embodiments, the structured case signals include the named entities, events, procedural milestones, argumentative units, citations, a combination thereof and the like.

In some embodiments, the directed multigraph includes a plurality of nodes and a plurality of edges.

In some embodiments, the plurality of nodes represent authorities. In some embodiments, the authorities are a cited legal source in the legal documents. In some embodiments, the authorities include cases identified based on extracted case citations and statutes identified based on extracted statute citations, a combination thereof and the like.

In some embodiments, the plurality of edges represent citations among the authorities. In some embodiments, the plurality of edges are annotated based on one or more attributes of the extracted case citations, one or more attributes based on the extracted statute citations, a combination thereof and the like. In some embodiments, the one or more attributes include treatment polarity, quote length, frequency, a combination thereof and the like.

In some embodiments, a citation graph includes the directed multigraph.

In some embodiments, the LLM-assisted subsystem 120 is configured to apply quality gates to outputs. In some embodiments, the quality gates are checks to validate the outputs. In some embodiments, the outputs include the structured case signals. In some embodiments, the quality gates include a confidence score, a coverage score, calibration-derived metrics, a combination thereof and the like.

In some embodiments, low-confidence items are routed to a client device for human review, re-extraction with constrained templates, or both. In some embodiments, the client device includes a graphical user interface, a dashboard, a combination thereof and the like, through which input is received, and then the system processes the input with the previous information to generate a new output.

In some embodiments, the LLM-assisted subsystem is configured to identify structured legal matter data from the received legal documents. In some embodiments, the structured legal matter data includes structured case signals extracted from the legal documents and one or more structured attributes derived from the legal documents, the matter metadata, or a combination thereof and the like. In some embodiments, the structured legal matter data, structured case signals, structured attributes, a combination thereof and the like, are stored in the system repository 195.

In an embodiment, a knowledge representation subsystem 130 is configured to construct and store a legal ontology. In some embodiments, the legal ontology is stored in the system repository 195. In some embodiments, the legal ontology is a heterogeneous legal knowledge graph.

In some embodiments, the legal ontology includes typed nodes representing legal concepts. In some embodiments, each typed node is associated with an ontology concept type. In some embodiments, the ontology concept type includes Claim, Element, EvidenceType, StandardOfReview, Jurisdiction, Remedy, a combination thereof and the like.

In some embodiments, the knowledge representation subsystem 130 is configured to associate structured case signals to the ontology concept types.

In some embodiments, the knowledge representation subsystem 130 is further configured to instantiate the legal ontology based on the associations. In some embodiments, the knowledge representation subsystem 130 is configured to map structured case signals to respective legal ontology concept types and to generate typed predicates with provenance identifying source document spans for the structured case signals. In some embodiments, the knowledge representation subsystem 130 is further configured to instantiate ontology instances for the legal matter based on the typed predicates to produce a machine-readable case state.

In some embodiments, the knowledge representation subsystem 130 is configured to store a case state including facts represented as typed predicates corresponding to the legal ontology.

In some embodiments, the legal ontology includes concept types and roles for Rule 12(b) Motion, 12(b)(6) Ground, Plausibility Standard, and Sufficiency-of-Allegations, linked to StandardOfReview and Claim/Element nodes.

In some embodiments, the typed predicate is stored with provenance metadata including a document identifier, a paragraph identifier, token offsets referencing locations in machine-readable text, the case state, a combination thereof and the like, are stored in the system repository 195.

In some embodiments, the knowledge representation subsystem 130 is configured to store symbolic rules encoding legal tests as logic constraints applicable to the case state. In some embodiments, the symbolic rules are stored as Horn clauses and first-order templates encoding legal tests. For example, a negligence test is represented as a rule including duty, breach, causation, and damages.

In some embodiments, the symbolic rules are stored and retrieved from the system repository 195.

In some embodiments, symbolic rules encode Rule 12(b)(6) plausibility screening as logic constraints that evaluate whether complaint allegations, taken as true and viewed with reasonable inferences, support each essential element of a claim. In some embodiments, the rule template maps Claim→required Elements→supporting Allegation predicates; if any essential element lacks a supporting allegation node meeting a Plausibility Standard predicate, the Dismiss-under-12(b)(6) outcome is favored.

In some embodiments, the heterogeneous legal knowledge graph is stored in the system repository 195, in some embodiments the heterogeneous legal knowledge graph is stored as a compressed sparse representation.

In some embodiments, heterogeneous legal knowledge graph is compressed as the compress sparse representation by compressed sparse row adjacency matrices partitioned by edge type enabling relation-specific traversal and queries over typed edges.

In an embodiment, a predictive subsystem is configured to execute a predictive model. In some embodiments, the predictive model includes the text encoder, a graph model, a tabular model, a meta-learner, a combination thereof and the like.

In some embodiments, the text encoder includes a transformer fine-tuned on legal corpora. In some embodiments, the text encoder includes one or more task-specific heads configured to perform span classification and relation extraction over machine-readable text in normalized legal documents.

In some embodiments, the predictive model generates contextual embeddings from canonical text spans. In some embodiments, the canonical text spans include portions of machine-readable text limited by recorded boundaries generated by boundary emission.

In some embodiments, tokenization is performed using a domain vocabulary. In some embodiments, the domain vocabulary comprises a domain-adapted tokenizer vocabulary configured to represent legal drafting conventions and citation patterns as token units for encoding by a transformer-based encoder (e.g., the text encoder). In at least one embodiment, the contextual embeddings have 768 dimensions for tokenized canonical spans.

In some embodiments, pooled span representations are computed by pooling the token-level contextual embeddings corresponding to a canonical text span. In some embodiments, pooling includes CLS-token pooling, mean pooling, a combination thereof, and the like. In some embodiments, the pooled span representation is a fixed-length representation for the canonical text span.

In some embodiments, the pooled span representations are projected using a learned linear layer to generate a feature vector. In some embodiments, the feature vector is graph-compatible such as compatible with a graph model. In at least one embodiment, the feature vector is 256 dimensions.

In some embodiments, the predictive subsystem is configured to validate one or more embedding representations using one or more metrics including area under the curve (AUC) and expected calibration error (ECE). In at least one embodiment, the predictive subsystem is configured such that an ECE is less than 0.05 for a selected validation subset.

In some embodiments, pooled span representations are projected via a learned linear layer to yield feature vectors.

In some embodiments, the graph model includes GraphSAGE, GAT, a combination thereof and the like.

In some embodiments, the graph model is executed over a citation graph.

In some embodiments, the citation graph includes the directed multigraph.

In some embodiments, the citation graph includes a plurality of nodes. In some embodiments, each node among the plurality of nodes represents an authority. In some embodiments, the citation graph includes a plurality of edges. In some embodiments, each edge among the plurality of edges represents a citation annotated with one or more attributes. In some embodiments, the one or more attributes include treatment polarity and quote length, a combination thereof and the like.

In some embodiments, the plurality of nodes include case nodes, statute nodes, clause nodes, a combination thereof and the like. In some embodiments, the clause nodes corresponding to local text spans.

In some embodiments, each node among the plurality of nodes is associated with a node feature.

In some embodiments, the node feature includes a text-derived embedding. In some embodiments, the text-derived embedding for a case node or statute node is computed by encoding machine-readable text associated with the authority. In some embodiments, the text-derived embedding for a clause node is computed by encoding one or more canonical text spans delimited by recorded boundaries.

In some embodiments, the node feature includes structured metadata. In some embodiments, the structured metadata includes venue statistics, judge statistics, a combination thereof and the like.

In some embodiments, the predictive subsystem is configured to initialize node features for each case node, each statute node, each clause node, a combination thereof and the like. For example, letting v represent a case node or statute node, an embedding ev=LLM_{encode}(documentᵥ) is calculated from machine-readable text associated with the case or the statute. In some embodiments, LLM_{encode}(⋅) is performed by the text encoder, the predictive subsystem, a combination thereof and the like.

In some embodiments, structured metadata includes venue statistics, judge statistics, forum-specific rates, a combination thereof and the like. In some embodiments, the node feature includes structured attributes, including structured metadata.

In some embodiments, the clause node is initialized by encoding local text spans corresponding to one or more canonical text spans delimited by recorded boundaries.

In some embodiments, the structured metadata is concatenated with one or more text-derived embeddings to form a node feature vector.

In some embodiments, each node among the plurality of nodes includes a node state that is updated by message passing. In some embodiments, message passing includes computing neighbor aggregation weights based on edge type and edge feature, a combination thereof and the like. In some embodiments, the edge type includes cites, applies, distinguishes, a combination thereof and the like. In some embodiments, edge features include polarity, frequency, quote length, a combination thereof and the like. In some embodiments, when the graph model includes a graph attention network, message passing includes computing attention weights for neighbor aggregation. In some embodiments, the graph model propagates information across K layers. In at least one embodiment, K=3.

In some embodiments, for a node v and a message passing layer k, the graph model is configured to update a node state hᵥ^{(k)} to an updated node state hᵥ^{(k+1)} according to:

$${h}_{v}^{( k + 1 )} = σ ( {W}_{self} {h}_{v}^{( k )} + {Σ}_{\{ u ∈ N ( v ) \}} {α}_{\{ uv \}} {W}_{rel} [ t y p e ( u , v ) ] {h}_{u}^{( k )} )$$

wherein N(v) includes neighbor nodes of v, α_{{uv}} is the attention weight, α_{(u→v)}^{(k)} includes a neighbor aggregation weight, W_{(t(u→v))}^{(k)} includes an edge-type-specific transform for an edge type t(u→v), and σ(⋅) includes a nonlinearity. In some embodiments, when the graph model includes a graph attention network, the neighbor aggregation weight α_{(u→v)}^{(k)} includes an attention weight computed based on a compatibility score e_{(u→v)}^{(k)}, wherein e_{(u→v)}^{(k)}=LeakyReLU(a^{T} [W hᵤ^{(k)} ∥ W hᵥ^{(k)} ∥ φ(u→v)]) and α_{(u→v)}^{(k)}=softmaxᵤ(e_{(u→v)}^{(k)}), wherein φ(u→v) includes one or more edge features including polarity, frequency, and quote length, a combination thereof and the like.

In some embodiments, hierarchical pooling includes aggregating clause-node representations via a gated sum to produce a section-level representation, aggregating section-level representations via a gated sum to produce a document-level representation, and aggregating document-level representations to produce an outcome-classifier representation, a combination thereof and the like.

In some embodiments, the predictive model is trained on a training set including historical matters, normalized legal documents, extracted structured signals, outcome labels, a combination thereof and the like.

In some embodiments, the training set is augmented. In some embodiments, augmenting the training set includes applying label-preserving perturbations to machine-readable text while preserving dispositive legal meaning associated with a supervision label.

In some embodiments, augmenting includes templates and ontology-constrained paraphrases, including substituting synonymous non-dispositive terms while preserving dispositive meaning, reordering non-causal clauses while preserving causal structure relevant to the label, normalizing citations, injecting neutral context, a combination thereof and the like.

In some embodiments, the factual parameters include one or more structured attributes in the structured legal matter data. For example, an amount-in-controversy value is minimally perturbed in a manner that does not change jurisdictional satisfaction, and the augmented example generated by the counterfactual perturbation is assigned the supervision label of the originating example.

In some embodiments, augmented examples are validated. In some embodiments, validation includes a static analyzer configured to determine whether an essential element associated with the supervision label changed state. In some embodiments, the invalid augmented examples are discarded.

In some embodiments, training the predictive model includes enforcing training-time consistency by computing an auxiliary edge-reconstruction loss such that learned node representations align with graph topology.

In at least one embodiments, the auxiliary edge-reconstruction loss is: L_{edge}=−log P(edgeₑₓᵢₛₜₛ | hᵤ, hᵥ) using a dot-product decoder in order to prevent embedding drift from relational structure.

In some embodiments, training includes one or more auxiliary losses in addition to the auxiliary edge-reconstruction loss.

In some embodiments, the one or more auxiliary losses include precedent ranking via a pairwise margin loss and temporal consistency via regularization over embedding differences across time-adjacent graph snapshots, a combination thereof and the like.

In some embodiments, the tabular model includes gradient-boosted decision trees including XGBoost, LightGBM, a combination thereof and the like. In some embodiments, the tabular model is further configured to consume the structured metadata including judge historical statistics, motion type, time-to-ruling, forum-specific rates, a combination thereof and the like.

In some embodiments, the tabular model includes a bagging-based decision tree ensemble configured to reduce variance and mitigate overfitting by training a plurality of decision trees on randomized subsets of training data. In some embodiments, the bagging-based ensemble includes a Random Forest model in which each tree is trained using a bootstrap sample of training examples and split decisions are selected using a randomized subset of candidate features. In some embodiments, the Random Forest model outputs an uncalibrated outcome score, an uncalibrated outcome probability by aggregating votes, probabilities across the plurality of trees, a combination thereof and the like.

In some embodiments, training includes an auxiliary edge-reconstruction loss computed using a cross-entropy loss over observed edges and sampled non-edges. In some embodiments, the auxiliary edge-reconstruction loss is configured such that learned node representations align with graph topology for one or more edge types including cites, applies, and distinguishes.

In some embodiments, training the predictive model includes privacy-preserving federated training across a plurality of institutional clients without centralizing raw matter data.

In some embodiments, the institutional clients include law firms, insurers, courts, enterprise legal departments, a combination thereof and the like.

In some embodiments, each institutional client performs local training to generate local gradient updates for model parameters.

In some embodiments, federated training includes secure aggregation such that a central server aggregates client updates without accessing raw client updates and without accessing raw matter data.

In some embodiments, the secure aggregation includes additive masking configured to cancel in aggregate.

In some embodiments, federated training further includes (ε,δ)-differential privacy by clipping per-example gradients to a norm bound and injecting calibrated noise into updates to satisfy a privacy budget, a combination thereof and the like.

In some embodiments, federated training further includes client heterogeneity handling using FedProx, FedAvgM, a combination thereof and the like, to address client distribution shift by adding a proximal regularization term to a local training objective.

In some embodiments, the predictive model includes an ensemble stacking workflow using the meta-learner.

In some embodiments, base learners include a transformer head, the graph model, and gradient-boosted trees and produce first outputs including uncalibrated outcome scores.

In some embodiments, the base learners further include the bagging-based decision tree ensemble, including the Random Forest model.

In some embodiments, the meta-learner consumes the uncalibrated outputs of the transformer head, the graph model, the gradient-boosted decision trees, and the Random Forest model to generate an ensemble prediction.

In some embodiments, the meta-learner consumes the first outputs and generates an ensemble prediction as a second output.

In some embodiments, the meta-learner includes logistic regression with optional monotonicity constraints.

In some embodiments, the predictive model applies probability calibration per venue, per task, a combination thereof and the like.

In some embodiments, calibration includes isotonic regression, Platt scaling, temperature scaling, a combination thereof and the like, to produce calibrated probabilities.

In some embodiments, calibration quality is tracked using one or more calibration metrics including a Brier score estimate and expected calibration error, a combination thereof and the like.

In some embodiments, evaluation includes time-sliced evaluation in which cohorts are defined based on case timestamp and partitioned into time windows. In some embodiments, the calibration is performed on earlier windows and testing is performed on later windows to reduce temporal leakage.

In some embodiments, the predictive model outputs conformal prediction sets providing empirical coverage consistent with a user-specified miscoverage rate α.

In some embodiments, the user-specified miscoverage rate α defines a target reliability level for the conformal prediction sets. In these embodiments, the predictive model is configured such that the conformal prediction set provides empirical coverage of at least 1−α over a selected evaluation cohort. In some embodiments, coverage includes a frequency with which a true outcome label is included in the conformal prediction set.

In some embodiments, the predictive model computes nonconformity scores using calibrated probabilities and outputs a set-valued prediction Γₐ(x*) including candidate outcomes with p-values exceeding a. In some embodiments, the predictive model incorporates graph-derived representations into conformal scoring by treating node embeddings as features consumed by a nonconformity computation, thereby incorporating uncertainty derived from graph outputs.

In some embodiments, when producing text outputs including textual rationales, issue labels, a combination thereof and the like, the predictive model returns a text prediction set using rank- and likelihood-based nonconformity and outputs uncertainty information including a highest-probability candidate included in the set, set size, a combination thereof and the like.

In an embodiment, a neural-symbolic integration subsystem 140 is configured to integrate symbolic rules with outputs of one or more neural prediction models such that predictions are constrained by legal-test consistency.

In some embodiments, the one or more neural prediction models include one or more of the text encoder, the graph model, a combination thereof and the like.

In some embodiments, the neural-symbolic integration subsystem 140 is configured to implement a calibration-first learning loop in which calibration information is incorporated into training of symbolic constraints. In some embodiments, calibration error informs symbolic rule weight adjustments such that rule satisfaction penalties are adaptively weighted.

In some embodiments, the predictive model is configured to compute a classification nonconformity score for calibration examples (xᵢ,yᵢ) using a calibrated probability \hat{p}(y|x), wherein A(xᵢ,yᵢ)=1−\hat{p}(yᵢ|xᵢ). In some embodiments, for a new matter input x*, the predictive model is configured to compute, for each candidate outcome y, a p-value is computed based on:

$${p}_{y} = ( \vert \{ i : A ( {x}_{i} , {y}_{i} ) \geq 1 - \hat{p} ( y \vert {x}^{⋆} ) \} \vert + 1 ) / ( \vert Cal \vert + 1 )$$

and to output a conformal prediction set Γ_{α}(x*)={y:p_{y}>α}, wherein α includes a user-specified miscoverage rate.

In some embodiments, the predictive model is configured to generate a motion-to-dismiss outcome prediction for a Rule 12(b)(6) matter based on pleadings and briefing. In such an embodiment, extracted argumentative units include asserted elements and alleged facts. In some embodiments, the neural-symbolic integration subsystem 140 is configured to enforce consistency with one or more pleading-standard constraints when generating, repairing, a combination thereof and the like, predicted outcomes. In some embodiments, the predictive model is configured to generate a summary judgment outcome prediction for a negligence matter. In some embodiments, the knowledge representation subsystem 130 is configured to store predicates corresponding to duty, breach, causation, damage, a combination thereof and the like. In some embodiments, the neural-symbolic integration subsystem 140 is configured to enforce a legal-element consistency constraint by suppressing an outcome prediction. For example, the outcome prediction that a moving party is granted summary judgment is suppressed that when the case state indicates that at least one required prerequisite for summary judgment is unmet, not present, missing, a combination thereof and the like.

In some embodiments, the predictive model is configured to generate a coverage-related outcome prediction for an insurance dispute, including predicting a duty-to-defend determination, indemnity exposure, a combination thereof and the like. In some embodiments, the extracted signals include policy provisions, alleged causes of action, exclusions, a combination thereof and the like. In some embodiments, the output subsystem 180 is configured to output an explanation identifying policy language spans and pleadings spans associated with the predicted determination.

In some embodiments, a training objective for the one or more neural prediction models is configured such that high-confidence symbolic violations are penalized more heavily than low-confidence symbolic violations, thereby reducing brittle rule enforcement that would otherwise override strong statistical evidence.

In some embodiments, the neural-symbolic integration subsystem 140 is configured to perform training-time constraint learning by incorporating rule-satisfaction penalties into a loss function used to train the one or more neural prediction models.

In some embodiments, training-time constraint learning includes adding loss terms for rule satisfaction to the training objective.

In some embodiments, for each rule r, the neural-symbolic integration subsystem 140 computes a soft truth value τᵣ∈[0,1] and adds a loss contribution proportional to (1−τᵣ). In some embodiments, τᵣ is computed using fuzzy-logic semantics including Lukasiewicz t-norm, product t-norm, a combination thereof and the like, applied over grounded predicates derived from the case state.

In some embodiments, the neural-symbolic integration subsystem 140 is configured to perform inference-time repair by post-processing prediction outputs to enforce one or more symbolic constraints.

In some embodiments, inference-time repair includes post-processing raw prediction outputs using a constraint enforcement layer including an integer linear program solver, a satisfiability solver, a combination thereof and the like, to prevent logically inconsistent outcomes.

For example, a prediction indicating “grant summary judgment for defendant” is prevented when a required element predicate is marked unmet in the case state.

In some embodiments, the hierarchical compression module 145 is configured to perform hierarchical compression over machine-readable text for compaction, retrieval, explanation support, a combination thereof and the like.

In some embodiments, the hierarchical compression module 145 is configured to compute salience using semantic and positional kernels over embeddings and positions and to select sentences, thereby enabling the capturing of salient content across the document and reducing redundancy under length constraints.

In some embodiments, the hierarchical compression module 145 is configured to perform single-pass compression. In such an embodiment, embeddings are defined as (eᵢ) and positions are defined as (pᵢ), weights between tokens (i,j) is defined as: [w_{{ij}}=\exp!\left(−\frac{|eᵢ−eⱼ|²}{2\sigmaₛ²}\right)\cdot\exp!\left(−\frac{|pᵢ−pⱼ|²}{2\sigmaₚ²}\right)]. In some embodiments, salience score is computed as (sᵢ=\sumⱼ w_{{ij}}\cdot aⱼ) where (aⱼ) is argumentative importance (from the encoder). In some embodiments, sentences maximizing normalized (S=\sum_{{i\in \text{summary}}} sᵢ) subject to coverage are selected. In some embodiments, w_{{ij}} is Maximal Marginal Relevance.

In some embodiments, the hierarchical compression module 145 is configured to perform multi-pass compression. In some embodiments, each pass in the multi-pass compression computes salience for a current document representation and retains top-ranked sentences according to a compression ratio within a configurable range.

In some embodiments, embeddings are updated by re-encoding retained sentences in context of a compacted representation, and argumentative importance is refreshed using a rhetorical role classifier.

In some embodiments, the hierarchical compression module 145 is configured to link compressed representations to a graph by creating a summary node for a compaction level and connecting the summary node to an original document node and constituent sentence nodes to support multi-resolution retrieval and explanation.

In some embodiments, the hierarchical compression module 145 is configured to compute bilateral weights between token indices i and j based on token embeddings eᵢ and eⱼ and token positions pᵢ and pⱼ according to: wᵢⱼ=exp(−(∥eᵢ−eⱼ∥²)/(2σₛ²))·exp(−(∥pᵢ−pⱼ∥²)/(2σₚ²)), wherein σₛ includes a semantic bandwidth parameter, and σₚ includes a positional bandwidth parameter. In some embodiments, the hierarchical compression module 145 is configured to compute token salience sᵢ according to sᵢ=Σj wᵢⱼ·aⱼ, wherein aⱼ includes an argumentative importance score generated by a rhetorical role classifier.

In some embodiments, the hierarchical compression module 145 is configured to select sentences to maximize a summary objective S=Σ(i∈summary) sᵢ subject to coverage constraints and redundancy constraints. In some embodiments, the redundancy constraint includes using maximal marginal relevance scoring incorporating the bilateral weights wᵢⱼ.

In some embodiments, the hierarchical compression module 145 is configured to perform multi-pass compression over a document representation Dₖ, wherein each pass retains a top-ranked subset of sentences according to a compression ratio ρ within a range from 0.3 to 0.5.

In some embodiments, the hierarchical compression module 145 is configured to terminate multi-pass compression when |Dₖ| is less than or equal to a target threshold T_{target}. In some embodiments, the hierarchical compression module 145 is configured when a number of passes k reaches a maximum pass count Kₘₐₓ.

In some embodiments, the hierarchical compression module 145 is configured to perform adaptive bandwidth scheduling by decreasing semantic bandwidth according to σₛ^{(k)}=σₛ⁽⁰⁾·β^{k}, wherein β is approximately 0.8, while maintaining a positional bandwidth σₚ to preserve document flow.

In some embodiments, the hierarchical compression module 145 is configured to perform adaptive bandwidth scheduling for the semantic and positional kernels used to compute sentence salience across passes.

In some embodiments, the hierarchical compression module 145 is configured to receive as input a normalized document D together with recorded boundaries from boundary segmentation, sectional segmentation, a combination thereof and the like, and outputs a compacted representation C of the normalized document at one or more target lengths.

In some embodiments, the hierarchical compression module 145 is configured to operate over a selectable unit of selection; in at least one embodiment, the unit of selection is a sentence obtained by sentence segmentation aligned to canonical text spans and section boundaries.

In some embodiments, sentence selection for compaction uses Maximal Marginal Relevance (MMR) to balance coverage and de-duplication. In some embodiments, given a candidate sentence x and the current selected set S, the selection score is

$$M M R ( x ) = λ \cdot Sim ( x , D ) - ( 1 - λ ) \cdot {max}_{s ∈ S} Sim ( x , s ) ,$$

where D is a document-level representation and Sim(⋅,⋅) includes cosine similarity over sentence embeddings derived from the semantic-positional bilateral kernel. In some embodiments, λ∈[0,1] trades off relevance and redundancy, and λ is increased in later passes to emphasize novelty after initial coverage.

In some embodiments, a kernel bandwidth parameter σ is annealed across compression passes p according to a schedule σ^{(p)}=σ⁽⁰⁾·β^{p} with β∈(0,1), thereby sharpening salience to favor increasingly specific sentences in later passes while earlier passes preserve broader coverage.

In some embodiments, the annealing schedule is document-adaptive, wherein β, σₛ⁽⁰⁾, s⁽⁰⁾, σₚ⁽⁰⁾, a combination thereof and the like, is selected based on redundancy and coverage diagnostics computed after each pass, including a redundancy score r(S) and coverage score c(S), and the next-pass parameters are chosen to reduce r(S) subject to maintaining c(S) above a threshold.

In some embodiments, lower and upper bounds are enforced on σ^{(p)} to prevent degeneration, including σₘᵢₙ≤σ^{(p)}≤σₘₐₓ. In some embodiments, the schedule is reset when passage-level salience variance falls below a threshold.

In an embodiment, an explainable AI subsystem 150 is configured to provide transparency for legal outcome predictions by generating attribution outputs integrated into a prediction workflow.

In some embodiments, the explainable AI subsystem generates attribution outputs for the bagging-based decision tree ensemble by determining feature importance values for tabular features, matter metadata, structured attributes, a combination thereof and the like, consumed by the ensemble and outputting, for display in the output file, a ranked list of matter metadata, structured metadata, tabular features, a combination thereof and the like, associated with the outcome prediction based on the important values.

In some embodiments, the explainable AI subsystem 150 is configured to compute local token and finding importance by computing attribution scores, including SHAP values over feature inputs used by the predictive model, wherein the feature inputs include transformer-derived features, graph embedding features, and tabular features, a combination thereof and the like. In some embodiments, the SHAP values are computed over tabular features, including venue statistics, judge statistics, and procedural history to identify which structured metadata drove the outcome prediction, and attention rollout and gradient-based saliency scores are computed over transformer-derived features to highlight influential tokens and text spans in the normalized legal documents.

In some embodiments, the explainable AI subsystem 150 is configured to render attributions by highlighting text spans and associating highlighted spans with findings used by predictive inference and calibration.

In some embodiments, the explainable AI subsystem 150 is configured to generate a rule-level trace by identifying satisfied legal rules and outputting a trace linking a predicted outcome to satisfied rules. In some embodiments, the trace includes a path of support from an outcome back to claims, elements, and evidence represented in the legal ontology and the case state.

In some embodiments, the explainable AI subsystem 150 is configured to generate counterfactual explanations by applying minimal perturbations to factual inputs and re-evaluating predicted outcomes under the perturbations using a same calibration mapping so that counterfactual outputs are comparable to original calibrated probabilities. In some embodiments, the factual input is a structured attribute in the structured legal matter data.

In some embodiments, the explainable AI subsystem 150 is configured to generate a judge profile roll-up by presenting historical judicial tendencies with confidence intervals and outputting cohort identifiers, calibration metadata, a combination thereof and the like, such that judge-specific context is integrated into explanation outputs.

In some embodiments, the explainable AI subsystem 150 receives attribution signals derived from the transformer-based encoder, text encoder, tabular feature inputs, a combination thereof and the like, determines token-level importances and intermediate factor contributions, generates rule-level traces including provenance pointers to source paragraphs or sentences supporting satisfied legal rules, and outputs outcome-level explanations including counterfactual deltas computed using the same calibration mapping.

In some embodiments, the explainable AI subsystem 150 is configured to compute attribution scores using one or more explanation techniques including SHAP and LIME, a combination thereof and the like. In some embodiments, the explainable AI subsystem 150 is configured to generate user-facing explanation narratives that translate token-level attributions, factor-level contributions, and rule-level traces into a user-friendly explanation format accessible to legal professionals, including identifying supporting evidence spans, applicable legal standards, and contributions of judge and venue features to a predicted outcome.

In some embodiments, the analytics system 100 is deployed on an on-premise environment, within a virtual private cloud environment, a combination thereof and the like.

In some embodiments, the security and operation subsystem 160 is configured to implement key management, encryption of stored artifacts, immutable audit logging, and access controls, a combination thereof and the like, for operation based on the deployment.

In some embodiments, the security and operation subsystem 160 is configured to deploy within an on-premise environment, within a virtual private cloud environment, a combination thereof and the like.

In some embodiments, the security and operation subsystem 160 is configured to implement key management using a key management service and to protect stored artifacts using encryption.

In some embodiments, the security and operation subsystem 160 is configured to quantize one or more models for efficient inference while maintaining extraction and prediction performance within specified tolerances.

In some embodiments, the security and operation subsystem 160 is configured to store indexed data in encrypted indices and to persist an immutable audit log including hash-chained entries to support auditability and forensic traceability.

In some embodiments, the security and operation subsystem 160 is configured to enforce access control using per-matter compartments, enforce redaction services and personally identifiable information minimization, and enforce retention policies using cryptographic erasure.

In some embodiments, the security and operation subsystem 160 is configured to support compliance with data protection frameworks by enforcing data minimization, purpose limitation, access logging, retention controls for matter data, implementing deletion, cryptographic erasure responsive to retention policy triggers, maintaining auditability of access to protected matter compartments, a combination thereof and the like.

In some embodiments, an entity tracking subsystem 170 is configured to determine whether a first masked entity mention and a second masked entity mention correspond to a same real-world entity without de-anonymization. In some embodiments, the masked entity mention (including the first masked entity mention and the second masked entity mention) include typed surrogates processed without materializing raw entity names.

In some embodiments, the entity tracking subsystem 170 is configured to construct a co-reference graph H=(Z,F), wherein Z includes anonymized mention nodes and F includes compatibility edges based on heuristics including same docket, same entity type, and temporal proximity within a threshold time window.

In some embodiments, each anonymized mention node includes features including a context embedding derived from a context window surrounding a masked mention, an entity type, docket metadata, a combination thereof and the like.

In some embodiments, the entity tracking subsystem 170 is configured to compute semantic similarity potentials using cosine similarity between context embeddings and to compute graph-structure potentials based on docket continuity and citation flow, a combination thereof and the like.

In some embodiments, the entity tracking subsystem 170 is configured to compute legal-rule potentials, including role consistency and temporal plausibility, a combination thereof and the like.

In some embodiments, combined potentials are learned from labeled co-reference data.

In some embodiments, the entity tracking subsystem 170 is configured to infer identity clusters. In some embodiments, the clusters are inferred using belief propagation and mention pairs are clustered when posterior probabilities exceed a threshold.

In some embodiments, the entity tracking subsystem performs inference via belief propagation over the co-reference graph. In some embodiments, beliefs bᵢ(cluster_{id}) are initialized uniformly, and for each edge (i,j), messages are computed according to m_{{i→j}}(c)∝Σ_{{c′}}bᵢ(c′)·exp(ψᵢⱼ·δ(c=c′)). In some embodiments, beliefs are updated according to bⱼ(c)∝bⱼ(c)·Π_{{i∈N(j)}}m_{{i→j}}(c). In some embodiments, inference terminates after T iterations or when a marginal change in beliefs is less than ε. In some embodiments, mention pairs are clustered when posterior probability P(zᵢ≡zⱼ) exceeds a threshold τ. In at least one embodiment, τ=0.7. In at least one embodiment, the convergence threshold is ε=0.01.

In some embodiments, one or more of T and E are configurable parameters selected based on validation performance, desired precision-recall tradeoffs, a combination thereof and the like.

In some embodiments, the entity tracking subsystem 170 is configured to preserve privacy, wherein privacy is preserved by operating on anonymized identifiers and embeddings, and differential privacy noise is added to aggregate co-reference statistics responsive to queries, a combination thereof and the like.

In some embodiments, the entity tracking subsystem 170 is configured to define the temporal proximity heuristic using a threshold time window, wherein the threshold time window is 90 days in at least one embodiment. In some embodiments, the entity tracking subsystem 170 is configured to limit propagation of compatibility signals across the citation graph using a hop limit, wherein the hop limit is three hops in at least one embodiment. In some embodiments, for a pair of anonymized mention nodes zᵢ and zⱼ, the entity tracking subsystem 170 is configured to compute a combined compatibility potential Φ(zᵢ,zⱼ)=wₛ·Sim(zᵢ,zⱼ)+w_{d}·Dock(zᵢ,zⱼ)+wᵣ·Role(zᵢ,z₁)+wₜ·Temp(zᵢ,zⱼ), wherein Sim includes a semantic similarity potential based on cosine similarity of context embeddings, Dock includes a docket continuity potential, Role includes a role consistency potential, Temp includes a temporal plausibility potential, and weights wₛ, w_{d}, wᵣ, and wₜ are learned using supervised training on labeled co-reference data.

In some embodiments, when compatibility is propagated along a path of edges in the citation graph, the entity tracking subsystem 170 is configured to aggregate compatibility along the path using a geometric mean of edge-wise compatibility contributions.

In an embodiment, an output subsystem 180 is configured to output structured results for programmatic access and user presentation.

In some embodiments, the output subsystem 180 is configured to output predicted outcome labels with class identifiers including grant, deny, affirm, reverse, liability bins, a combination thereof and the like.

In some embodiments, the output subsystem 180 is configured to output calibrated probabilities including probability arrays per outcome class and to output confidence scores including extraction confidence and aggregate prediction confidence based on calibration metrics.

In some embodiments, the output subsystem 180 is configured to output a litigation risk assessment including settlement valuation ranges derived from predicted award distributions, predicted exposure distributions, a combination thereof and the like.

In some embodiments, the output subsystem 180 is configured to output conformal prediction sets including set-valued predictions with empirical coverage metadata.

In some embodiments, the output subsystem 180 is configured to output multi-level explanations including token importances, factor contributions, rule traces, and counterfactual deltas.

In some embodiments, the output subsystem 180 is configured to output judge profile data including judicial statistics and cohort identifiers.

In some embodiments, the output subsystem 180 is configured to transmit outputs via an application programming interface by generating JSON objects with schema versioning and provenance metadata including model version, calibration window, jurisdiction, and data sources.

In some embodiments, the output subsystem 180 is configured to associate each prediction with an audit trail including hash-chained immutable log entries, wherein each prediction is associated with a content hash of input features, a model checkpoint identifier, and a timestamp for forensic traceability.

In some embodiments, the output subsystem 180 is configured to render an interface presentation including a multi-level visualization showing token-to-factor-to-rule-to-outcome flow and to enable drill-down from predicted outcomes to supporting evidence spans.

In some embodiments, the output subsystem 180 is configured to integrate with a distributed ledger, blockchain, a combination thereof and the like, to support immutable record-keeping for one or more of document ingestion events, model outputs, and audit trails, a combination thereof and the like.

In some embodiments, the predictive subsystem is configured to implement adaptive learning, continuous learning, a combination thereof and the like, to update one or more models in response to new case law, new filings, evolving procedural patterns, a combination thereof and the like.

In some embodiments, the LLM-assisted subsystem 120 is configured to provide multilingual support for processing legal texts in multiple languages for international and cross-border applications, a combination thereof and the like.

In some embodiments, the predictive subsystem is configured to incorporate fairness metrics and bias detection to evaluate and reduce disparate performance across cohorts and jurisdictions, a combination thereof and the like, thereby supporting equitable predictions.

In some embodiments, for a motion to dismiss under Rule 12(b)(6), the LLM-assisted subsystem 120 analyzes the complaint and associated briefing to extract structured case signals from the normalized legal documents using language-model-assisted, non-generative analysis.

In some embodiments, the structured case signals include asserted causes of action, motions, dispositions, and requested relief identified via extractive span selection, and the LLM-assisted subsystem 120 further performs argumentative unit segmentation by splitting filings into claims, premises, rebuttals, standards of review, and requested relief. In some embodiments, the LLM-assisted subsystem 120 further extracts case and statute citations to support construction of a citation graph in which authorities (e.g., cases and statutes) are represented as nodes and citations are represented as edges annotated with attributes such as treatment polarity and quote length.

In some embodiments, the knowledge representation subsystem 130 maps at least a portion of the extracted structured case signals to a legal ontology and stores a case state as typed predicates with provenance metadata linking the predicates to source document locations including document identifiers, paragraph identifiers, and token offsets.

The neural-symbolic integration subsystem 140 then applies symbolic rules encoding legal tests as logic constraints and integrates such constraints with neural prediction outputs using a differentiable rule-satisfaction layer or an inference-time constraint enforcement layer to promote consistency between predicted outcomes and the case state represented in the knowledge representation subsystem 130.

In some embodiments, the neural-symbolic integration subsystem 140, the LLM-assisted subsystem 120, a combination thereof and the like, are each configured to associate outputs with confidence and coverage measures, and low-confidence items are routed through quality gates to human review and/or re-extraction with constrained templates. In some embodiments, once the extracted structured case signals and the case state are generated, the predictive subsystem executes a predictive model including a transformer-based text encoder and a graph model operating over the citation graph and/or heterogeneous legal knowledge graph to generate an outcome prediction for the matter.

In some embodiments, for a Rule 12(b)(6) matter, the predictive workflow is applied to generate a partial dismissal prediction in which the matter outcome corresponds to dismissal of one or more identified duplicative quasi-contract claims with calibrated confidence. In some embodiments, the predictive subsystem calibrates outcome probabilities and generates conformal prediction sets using a user-specified miscoverage rate α to provide empirical coverage consistent with 1−α. In some embodiments, the output subsystem 180 outputs structured results including calibrated probabilities, confidence scores, conformal prediction sets, and multi-level explanations that link predictions to specific document spans and provenance (e.g., token→factor→rule→outcome), thereby enabling defensible review.

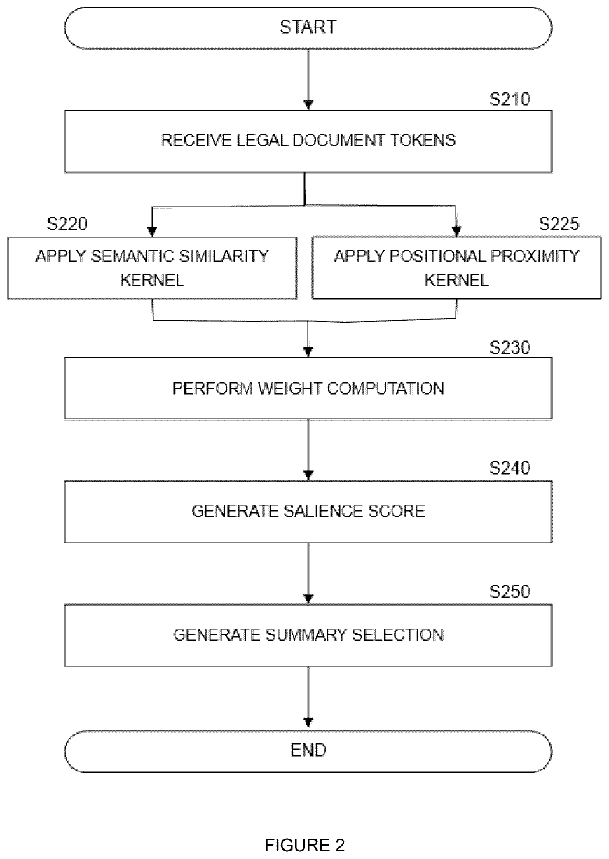

FIG. 2 is an example of a bilateral text filter pipeline, implemented in accordance with an embodiment.

In some embodiments, the bilateral text filter pipeline is configured to perform extractive summarization and compaction of machine-readable legal text while preserving argumentative salience and document flow. In some embodiments, the bilateral text filter pipeline is executed as part of a hierarchical bilateral compression module.

At S210, the pipeline receives a sequence of legal document tokens, wherein each token i is associated with a semantic embedding eᵢ (e.g., derived from a transformer encoder) and a positional index pᵢ representing token position within a canonicalized document representation. In some embodiments, the tokens correspond to tokenized canonical spans, other normalized text regions suitable for extractive operations, a combination thereof and the like.

At S220, a semantic similarity kernel is applied to the legal document tokens. In some embodiments, the semantic similarity kernel is applied between token indices i and j using their embeddings. In at least one embodiment, the semantic kernel is Gaussian in embedding space and is computed as:

$${k}_{s} ( i , j ) = exp ( - \frac{{‖ {e}_{i} - {e}_{j} ‖}^{2}}{2 {σ}_{s}^{2}} ) ,$$

where σₛ is a semantic bandwidth parameter that controls how quickly semantic affinity decays with embedding distance.

At S225, a positional proximity kernel is applied to the legal document tokens. In some embodiments, the positional proximity kernel is applied based on the token positions pᵢ and pᵢ to preserve local coherence and avoid selecting semantically related but contextually distant tokens. In at least one embodiment, the positional kernel is Gaussian in position space and is computed as:

$${k}_{p} ( i , j ) = exp ( - \frac{{‖ {p}_{i} - {p}_{j} ‖}^{2}}{2 {σ}_{p}^{2}} ) ,$$

where σₚ is a positional bandwidth parameter.

At S230, bilateral weights wᵢⱼ are computed based on the semantic similarity and positional proximity. In some embodiments, the semantic similarity and the positional proximity are combined so that both semantic relatedness and positional closeness contribute to influence. In at least one embodiment:

$${w}_{ij} = {k}_{s} ( i , j ) \cdot {k}_{p} ( i , j ) = exp ( - \frac{{‖ {e}_{i} - {e}_{j} ‖}^{2}}{2 {σ}_{s}^{2}} ) \cdot exp ( - \frac{{‖ {p}_{i} - {p}_{j} ‖}^{2}}{2 {σ}_{p}^{2}} ) .$$

In some embodiments, wᵢⱼ is computed over token pairs within a token window. In some embodiments, wᵢⱼ is computed over all tokens.

At S240, a salience score is generated. In some embodiments, the salience score is sᵢ. In some embodiments, the salience score includes an aggregation of the bilateral weights against one or more token-level, sentence-level, a combination thereof and the like, argumentative importance scores aⱼ, where ai reflects rhetorical or argumentative contribution (e.g., claim, premise, rebuttal, standard-of-review). In at least one embodiment, salience is computed as:

$${s}_{i} = {\sum }_{j} {w}_{i j} \cdot {a}_{j}$$

In some embodiments, aⱼ is computed by an encoder, a rhetorical role classifier, a combination thereof and the like. In some embodiments, when retained text is re-embedded in a compacted context representation D_{{k+1}}, the argumentative importance scores are updated by re-running the rhetorical role classifier on D_{{k+1}}. In some embodiments, aⱼ is updated to aⱼ^{(k+1)} for a subsequent compression pass by re-running the rhetorical role classifier on the re-embedded compacted representation.

At S250, a summary selection is generated. In some embodiments, the summary selection is based on one or more salience scores. In some embodiments, the summary selection is based on the salience scores that maximizes the salience score while satisfying coverage and redundancy constraints. In some embodiments, redundancy control is implemented using Maximal Marginal Relevance (MMR) such that candidate units are selected to increase coverage of salient content while penalizing overlap as measured by bilateral weights, embedding similarity, a combination thereof and the like. In some embodiments, the objective is to maximize a normalized summary score S=Σ_{i∈summary}sᵢsubject to length constraints and redundancy constraints, and a greedy selection procedure is used. In some embodiments, the maximized salience score is used to choose a set of sentences.

In some embodiments, the bilateral text filter pipeline of FIG. 2 is applied iteratively across multiple passes to generate progressively compacted representations (e.g., a long-form briefing reduced to intermediate and then executive-level summaries). In some embodiments, at pass k the pipeline retains a top-ranked subset of sentences according to a compression ratio ρ within a range (e.g., 0.3-0.5), re-embeds retained text in context for the next pass, updates argumentative importance scores, and terminates when a target length is reached or a maximum number of passes is met.

In some embodiments, the semantic bandwidth σₛ is adaptively decreased across passes according to σₛ^{(k)}=σₛ⁽⁰⁾·β^{k} (e.g., β≈0.8) while σₚ remains constant to preserve document flow.

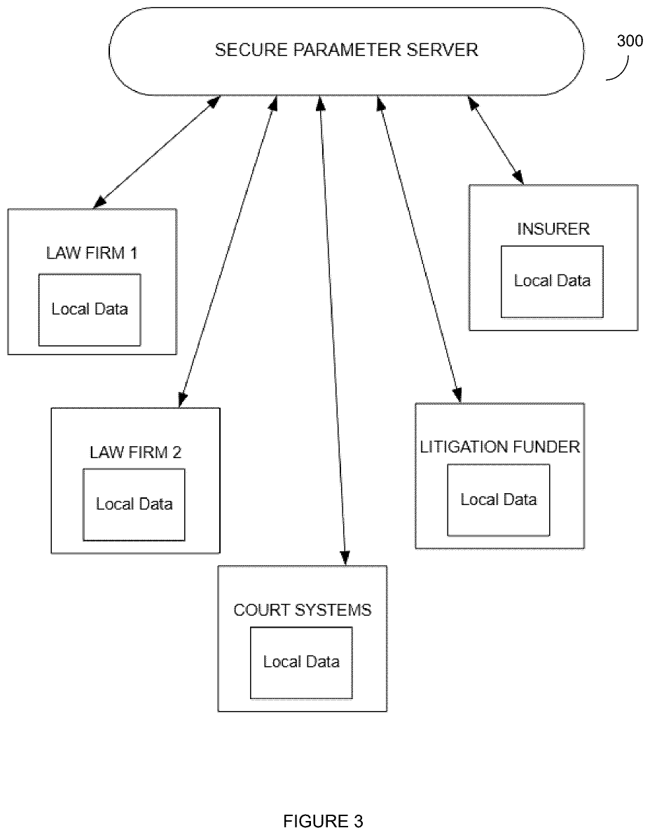

FIG. 3 is a diagram illustration of a federated learning topology 300, implemented in accordance with an embodiment.

In some embodiments, the federated learning topology 300 includes training one or more prediction models across multiple institutional clients while keeping raw matter data local to each institution.

In some embodiments, the federated learning topology 300 includes a secure parameter server and a plurality of clients comprising one or more law firms, court systems, and insurers, and in some embodiments additional stakeholders (e.g., litigation funders) participate as clients that benefit from the trained models while retaining their local datasets.

In some embodiments, each client maintains local data (e.g., local matter files, pleadings, motions, orders, and derived features) and performs local training on a shared model architecture to generate parameter updates. In these embodiments, local training produces gradients gₖ (e.g., g₁ . . . g₅ as depicted) for model parameters, and the gradients are transmitted (directly or in masked form) to the secure parameter server for aggregation.

In some embodiments, the local training includes updating multiple components of a full pipeline (e.g., text encoder components, graph-model weights, and neural-symbolic constraint parameters) while preserving confidentiality by preventing local examples, documents, or embeddings from leaving the client boundary.

In some embodiments, the secure parameter server performs secure aggregation such that the server does not observe any client's raw gradients or training data and instead computes only an aggregate update (e.g., Σₖ gₖ). In at least one embodiment, secure aggregation is implemented using additive masking, wherein clients add random masks to their updates that cancel in the aggregate, so that the server only computes the sum of masked updates and cannot reconstruct any individual client update.

In some embodiments, the secure parameter server updates a global parameter vector (e.g., θ_{global}) using the aggregated gradient information and distributes updated parameters back to the clients for subsequent local training rounds.

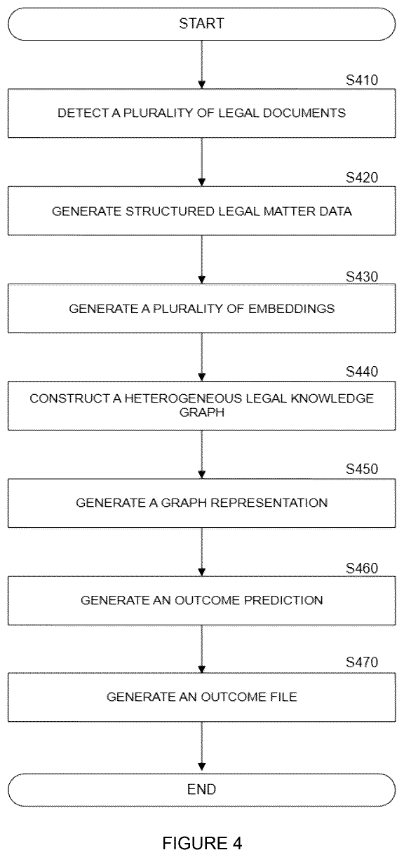

FIG. 4 is an example flowchart of a method for processing case-related electronic documents to generate an output file, implemented in accordance with an embodiment.

At S410, a plurality of legal documents are received as electronic files. In some embodiments, the plurality of legal documents is associated with a legal matter. In some embodiments, the legal documents are normalized. In some embodiments, a document processing subsystem is configured to normalize the legal documents prior to downstream extraction and embedding generation. In some embodiments, the normalization includes synonym normalization for legal terms, citation canonicalization according to a Bluebook-style citation, temporal standardization to coordinated universal time, normalization of party roles, a combination thereof, and the like.

For example, a document ingestion subsystem receives an electronic complaint, an answer, a motion to dismiss, a docket sheet, and one or more exhibits as PDF files and text files. The subsystem normalizes citations by converting short-form citations into canonical case identifiers, normalizes dates into coordinated universal time, and normalizes party roles by mapping “Plaintiff,” “Petitioner,” and “Appellant” into a canonical role label set.

At S420, structured legal matter data is generated based on the received legal documents. In some embodiments, a structured data generation subsystem is configured to generate the structured legal matter data by extracting fields from the legal documents using a language model, a rules-based parser, a trained classifier, a combination thereof, and the like. In some embodiments, the structured legal matter data includes extracted entities, extracted events, extracted procedural posture information, extracted legal citations, extracted remedies, extracted damages requests, extracted claim types, extracted defenses, a combination thereof, and the like. In some embodiments, the structured legal matter data includes provenance associations that link extracted fields to one or more source spans in the legal documents.

For example, the structured data generation subsystem extracts party names and roles from the caption, extracts asserted causes of action from a “Claims for Relief” section, extracts cited statutes and cited precedents from citation spans, and extracts a demanded damages amount from a prayer-for-relief paragraph, while storing offsets that identify the source paragraph and line range for each extracted field.

At S430, a plurality of embeddings are generated for at least a portion of the legal documents. In some embodiments, the predictive subsystem includes a text encoder. In some embodiments, the text encoder identifies a plurality of text spans in the legal documents, tokenizes the text spans based on a domain vocabulary, and encodes the tokenized text spans using a transformer-based encoder. In some embodiments, the embeddings include contextual embeddings for tokens, spans, clauses, sections, and documents, a combination thereof, and the like. In some embodiments, the text encoder is configured to pool token-level embeddings into span-level embeddings using mean pooling, CLS pooling, attention pooling, a combination thereof, and the like. In some embodiments, the text encoder is configured to generate clause-level embeddings, section-level embeddings, and document-level embeddings by hierarchically aggregating lower-level embeddings. In some embodiments, the text encoder is configured to project pooled embeddings from a first dimension to a second dimension using a learned linear layer to generate node-feature-compatible embeddings.

For example, the text encoder selects a span containing “failure to state a claim under Rule 12(b)(6),” tokenizes the span using a legal domain vocabulary, encodes the tokens with a transformer-based encoder, mean-pools token embeddings to form a span embedding, projects the span embedding to a fixed-dimensional node feature vector, aggregates multiple span embeddings within a clause to form a clause-level embedding, aggregates clause-level embeddings to form a section-level embedding, and aggregates section-level embeddings to form a document-level embedding.

At S440, a heterogeneous legal knowledge graph is constructed. In some embodiments, the heterogeneous legal knowledge graph includes a plurality of nodes and a plurality of edges. In some embodiments, a graph construction subsystem is configured to construct the heterogeneous legal knowledge graph based on the structured legal matter data. In some embodiments, the plurality of nodes represents structured legal matter data, including a party, a claim, a defense, a cited statute, a cited precedent, a motion, a remedy, a jurisdiction, a judge, a damages request, a combination thereof, and the like. In some embodiments, the plurality of edges represents relationships including cites, asserts, disputes, requests, filed-in, decided-by, governed-by, supported-by, contradicted-by, related-to, a combination thereof, and the like. In some embodiments, at least a subset of nodes among the plurality of nodes include an embedding among the plurality of embeddings as node features.

For example, the graph construction subsystem creates a party node for “Acme Corp.”, a claim node for “breach of contract,” a remedy node for “injunctive relief,” and a precedent node for a cited case. The subsystem then creates edges indicating that the party asserts the claim, the claim requests the remedy, and the claim cites the precedent, while attaching span-derived embeddings to the claim node and the precedent node as node features.

At S450, a graph representation is generated by performing message passing on the heterogeneous legal knowledge graph using a graph neural network. In some embodiments, a graph neural network subsystem is configured to perform message passing using a relation-aware graph neural network, a graph attention network, a relational graph convolutional network, a combination thereof, and the like. In some embodiments, the message passing updates the node features based on neighborhood aggregation over incident edges and edge types. In some embodiments, the graph representation includes a graph-level embedding, a pooled node representation, a pooled subgraph representation, a combination thereof, and the like.

For example, the graph neural network subsystem updates a claim node representation by aggregating messages from a party node connected by an “asserts” edge, from a precedent node connected by a “cites” edge, and from a remedy node connected by a “requests” edge, with relation-specific weights, and then pools the updated node representations across the graph to form a fixed-length graph representation.

At S460, an outcome prediction is generated for the legal matter based on the graph representation. In some embodiments, a prediction subsystem is configured to generate the outcome prediction by applying a classifier to the graph representation. In some embodiments, generating the outcome prediction includes applying a meta-learner to outputs of a plurality of base learners, where the plurality of base learners includes the graph neural network, a transformer-based model, a tree-based model, a combination thereof, and the like. In some embodiments, the outcome prediction is calibrated by applying isotonic regression, Platt scaling, a combination thereof, and the like. In some embodiments, a prediction set is generated using conformal prediction to associate coverage metadata with the outcome prediction.

For example, the prediction subsystem generates an initial probability distribution over outcomes including “dismissed,” “settled,” and “plaintiff-prevails,” calibrates the probabilities using isotonic regression based on a calibration cohort, and then generates a conformal prediction set at a specified miscoverage rate to determine whether one outcome or multiple outcomes should be included as a coverage-controlled set.

At S470, an output file is generated. In some embodiments, the output file is an electronic file generated based on the received plurality of legal documents. In some embodiments, an output generation subsystem is configured to generate the output file as a JSON file, a PDF file, a word processing file, a combination thereof, and the like. In some embodiments, the output file includes the outcome prediction. In some embodiments, the output file further includes calibrated probabilities, confidence scores, a conformal prediction set with empirical coverage metadata, counterfactual deltas, settlement valuation ranges derived from predicted award distributions, evidence-linked explanations identifying source spans, provenance metadata identifying model version and configuration, a combination thereof, and the like.

For example, the output generation subsystem generates a JSON output file that includes: (i) an outcome prediction label, (ii) calibrated probabilities for each outcome class, (iii) a prediction set with coverage metadata, (iv) a ranked list of cited precedents and document spans that contributed to the prediction, (v) a counterfactual delta showing the change in calibrated probability responsive to a modification of a structured attribute such as a damages amount or jurisdiction label, a combination thereof and the like.

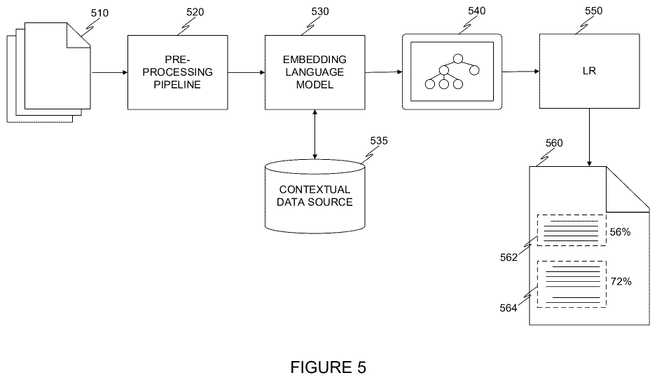

FIG. 5 is a processing pipeline, implemented in accordance with an embodiment.

In some embodiments, processing pipeline 500 generates an output file 560 based on legal documents 510. In some embodiments, the legal documents include electronic files. In some embodiments, the pipeline 500 is executed by analytics system 100 and includes a pre-processing pipeline 520, a text encoder 530, a contextual data source 535, a graph model 540, and a logistic regression (LR) model 550. In some embodiments, the output file 560 includes an outcome prediction and one or more associated probability values, and further includes one or more evidence-linked portions (including a first evidence-linked portion 562 and a second evidence linked portion 564) corresponding to locations in the received legal documents 510.

In some embodiments, the legal documents 510 include pleadings, motions, orders, docket entries, hearing transcripts, exhibits, statutory materials, regulatory materials, a combination thereof and the like. In some embodiments, the legal documents 510 are received as electronic files and include machine-readable text, scanned text requiring optical character recognition, or both.

In some embodiments, the pre-processing pipeline 520 is configured to normalize the legal documents 510 for downstream extraction and embedding generation. In some embodiments, normalizing includes optical character recognition, deduplication, MIME-type detection, layout-aware paragraph segmentation, citation normalization, canonicalization, date normalization, a combination thereof and the like. In some embodiments, the pre-processing pipeline 520 is further configured to perform boundary emission by identifying and recording canonical text spans corresponding to contiguous sequences of machine-readable text and by identifying and recording section boundaries delimiting the canonical text spans.

In some embodiments, the text encoder 530 is configured to generate embedding representations for at least a portion of the normalized legal documents 510. In some embodiments, the text encoder 530 includes a transformer-based encoder configured to tokenize text spans based on a domain vocabulary and encode the tokenized text spans to generate contextual embeddings. In some embodiments, the text encoder 530 is configured to pool token-level embeddings into span-level embeddings using CLS pooling, mean pooling, attention pooling, a combination thereof and the like, and is further configured to project pooled embeddings using a learned linear layer to generate fixed-dimensional feature vectors usable as node features for a graph model.

In some embodiments, the contextual data source 535 is configured to provide contextual information usable by the text encoder 530, the graph model 540, or both. In some embodiments, the contextual information includes matter metadata, structured metadata, court identifiers, judge identifiers, venue statistics, procedural posture indicators, motion-type indicators, time-to-ruling indicators, forum-specific rates, a combination thereof and the like. In some embodiments, the contextual data source 535 is stored in the system repository 195 and is accessed by the pipeline 500 to condition encoding, feature construction, graph construction, or a combination thereof and the like.

In some embodiments, the graph model 540 is configured to generate a graph representation based on a legal knowledge graph constructed from the legal documents 510, the contextual data source 535, or both. In some embodiments, the legal knowledge graph is a heterogeneous legal knowledge graph including a plurality of nodes and a plurality of edges, wherein the nodes represent structured legal matter data including parties, claims, defenses, motions, cited precedents, cited statutes, remedies, jurisdictions, judges, damages requests, a combination thereof and the like. In some embodiments, at least a subset of nodes include embedding feature vectors generated by the text encoder 530 as node features. In some embodiments, the graph model 540 includes a graph neural network configured to perform message passing to update node features based on edge types and neighborhood aggregation and to pool updated node features to generate the graph representation.

In some embodiments, the LR model 550 is configured to generate an outcome prediction based on the graph representation generated by the graph model 540. In some embodiments, the LR model 550 is a meta-learner configured to consume outputs from one or more base learners, including the graph model 540, a tabular model consuming structured metadata, a transformer-based model consuming text-derived features, a combination thereof and the like, and to generate a combined outcome prediction. In some embodiments, the LR model 550 outputs a probability value associated with an outcome class, and the probability value is calibrated using isotonic regression, Platt scaling, a combination thereof and the like.

In some embodiments, the output file 560 is generated based on the received legal documents 510 and includes the outcome prediction generated by the LR model 550. In some embodiments, the output file 560 is a JSON file, a PDF file, a word processing file, a combination thereof and the like. In some embodiments, the output file 560 includes one or more probability values (e.g., 56% and 72% as illustrated), and further includes evidence-linked portions 562, 564 that identify one or more document spans, paragraph locations, token offsets, or other provenance pointers corresponding to text that contributed to the outcome prediction, a combination thereof and the like.

For example, the pre-processing pipeline 520 normalizes a motion to dismiss and associated briefing, records canonical text spans and section boundaries, and outputs machine-readable spans for encoding. The text encoder 530 encodes a span corresponding to a legal standard and produces a span embedding projected to a node-feature-compatible vector. The graph model 540 performs message passing over a heterogeneous legal knowledge graph, including a motion node, a claim node, and one or more cited authority nodes having embedding node features. The LR model 550 generates an outcome prediction including a calibrated probability value. The output file 560 includes the probability value and highlights evidence-linked portions (including a first evidence-linked portion 562 and a second evidence linked portion 564) corresponding to the canonical text spans that supported the prediction.

In some embodiments, the evidence-linked portions (including the first evidence-linked portion 562 and the second evidence-linked portion 564) include highlighted or otherwise identified canonical text spans in the legal documents 510 that are linked, via provenance pointers, to the specific machine-readable text used to generate the outcome prediction. For example, a first evidence-linked portion 562 corresponds to a span in a motion or brief stating a governing legal standard (e.g., a Rule 12(b)(6) plausibility standard), and is associated with a document identifier, a paragraph identifier, and token offsets identifying the span location in the machine-readable text. In a further example, a second evidence-linked portion 564 corresponds to a span in a complaint or other filing that provides a key factual allegation or element-related premise used by the predictive workflow, and is likewise linked to stored provenance metadata. In some embodiments, the evidence-linked portions further include citation-bearing spans (e.g., case or statute citation text spans) that supported authority-aware features, requested-relief spans corresponding to prayer-for-relief text, procedural-posture spans identifying a motion type or milestone, a combination thereof and the like, wherein each evidence-linked portion is linked to a corresponding canonical text span recorded during boundary emission.

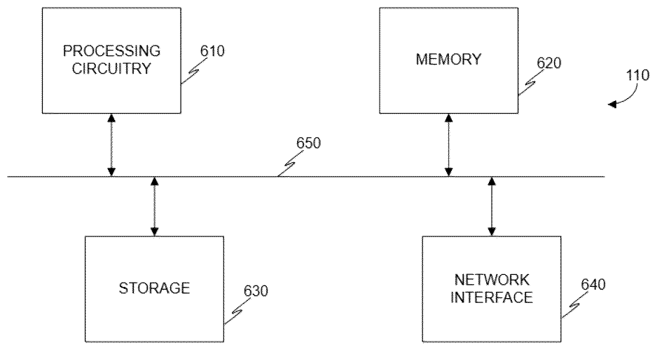

FIG. 6 is an example schematic diagram of a data ingestion subsystem 110 according to an embodiment. The data ingestion subsystem 110 includes, according to an embodiment, a processing circuitry 610 coupled to a memory 620, a storage 630, and a network interface 640. In an embodiment, the components of the data ingestion subsystem 110 are communicatively connected via a bus 650.

In certain embodiments, the processing circuitry 610 is realized as one or more hardware logic components and circuits. For example, according to an embodiment, illustrative types of hardware logic components include field programmable gate arrays (FPGAs), application-specific integrated circuits (ASICs), Application-specific standard products (ASSPs), system-on-a-chip systems (SOCs), graphics processing units (GPUs), tensor processing units (TPUs), Artificial Intelligence (AI) accelerators, general-purpose microprocessors, microcontrollers, digital signal processors (DSPs), and the like, or any other hardware logic components that are configured to perform calculations or other manipulations of information.

In an embodiment, the memory 620 is a volatile memory (e.g., random access memory, etc.), a non-volatile memory (e.g., read only memory, flash memory, etc.), a combination thereof, and the like. In some embodiments, the memory 620 is an on-chip memory, an off-chip memory, a combination thereof, and the like. In certain embodiments, the memory 620 is a scratch-pad memory for the processing circuitry 610.

In one configuration, software for implementing one or more embodiments disclosed herein is stored in the storage 630, in the memory 620, in a combination thereof, and the like. Software shall be construed broadly to mean any type of instructions, whether referred to as software, firmware, middleware, microcode, hardware description language, or otherwise. Instructions include, according to an embodiment, code (e.g., in source code format, binary code format, executable code format, or any other suitable format of code). The instructions, when executed by the processing circuitry 610, cause the processing circuitry 610 to perform the various processes described herein, in accordance with an embodiment.

In some embodiments, the storage 630 is a magnetic storage, an optical storage, a solid-state storage, a combination thereof, and the like, and is realized, according to an embodiment, as a flash memory, as a hard-disk drive, another memory technology, various combinations thereof, or any other medium which can be used to store the desired information.

The network interface 640 is configured to provide the data ingestion subsystem 110 with communication with, for example, user device, client device, graphical user interface, dashboard, a combination thereof and the like, according to an embodiment.

It should be understood that the embodiments described herein are not limited to the specific architecture illustrated in FIG. 6, and other architectures may be equally used without departing from the scope of the disclosed embodiments.

Furthermore, in certain embodiments the LLM-assisted subsystem 120, a knowledge representation subsystem 130, a neural-symbolic integration subsystem 140, a hierarchical compression module 145, an explainable artificial intelligence (AI) subsystem 150, a security and operation subsystem 160, an entity tracking subsystem 170, an output subsystem 180, a system repository 195, various combinations thereof, and the like, may be implemented with the architecture illustrated in FIG. 6. In other embodiments, other architectures may be equally used without departing from the scope of the disclosed embodiments.

As used herein, a language model refers to a computational model configured to process linguistic input and to generate, evaluate, or otherwise operate on sequences of linguistic units, such as characters, sub-words, words, tokens, symbols, or combinations thereof, by estimating probabilistic relationships among such units.

Language models, as described herein, may include large language models (LLMs), small language models (SLMs), and other neural or non-neural language modeling systems, without limitation as to model size, parameter count, architecture, or training methodology. Non-limiting examples of language models include transformer-based models such as GPT-family models, Claude-family models, BERT-family models, T5, BART, and derivatives or variants thereof, as well as functionally equivalent models developed in the future.

The various embodiments disclosed herein can be implemented as hardware, firmware, software, or any combination thereof. Moreover, the software is preferably implemented as an application program tangibly embodied on a program storage unit or computer-readable medium consisting of parts, or of certain devices and/or a combination of devices. The application program may be uploaded to, and executed by, a machine comprising any suitable architecture. Preferably, the machine is implemented on a computer platform having hardware such as one or more processing units (“PUs”), a memory, and input/output interfaces. The computer platform may also include an operating system and microinstruction code. The various processes and functions described herein may be either part of the microinstruction code or part of the application program, or any combination thereof, which may be executed by a PU, whether or not such a computer or processor is explicitly shown. In addition, various other peripheral units may be connected to the computer platform, such as an additional data storage unit and a printing unit. Furthermore, a non-transitory computer-readable medium is any computer-readable medium except for a transitory propagating signal.

All examples and conditional language recited herein are intended for pedagogical purposes to aid the reader in understanding the principles of the disclosed embodiment and the concepts contributed by the inventor to furthering the art, and are to be construed as being without limitation to such specifically recited examples and conditions. Moreover, all statements herein reciting principles, aspects, and embodiments of the disclosed embodiments, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

It should be understood that any reference to an element herein using a designation such as “first,” “second,” and so forth does not generally limit the quantity or order of those elements. Rather, these designations are generally used herein as a convenient method of distinguishing between two or more elements or instances of an element. Thus, a reference to first and second elements does not mean that only two elements may be employed there or that the first element must precede the second element in some manner. Also, unless stated otherwise, a set of elements comprises one or more elements.

As used herein, the phrase “at least one of” followed by a listing of items means that any of the listed items can be utilized individually, or any combination of two or more of the listed items can be utilized. For example, if a system is described as including “at least one of A, B, and C,” the system can include A alone; B alone; C alone; 2A; 2B; 2C; 3A; A and B in combination; B and C in combination; A and C in combination; A, B, and C in combination; 2A and C in combination; A, 3B, and 2C in combination; and the like.

What is claimed is:

1. A method for processing case-related electronic documents to generate an output file, comprising:
receiving a plurality of legal documents as electronic files, wherein the plurality of legal documents are associated with a legal matter;
generating a structured legal matter data based on the received plurality of legal documents;
generating a plurality of embeddings for at least a portion of the legal documents using a language model;
constructing a heterogeneous legal knowledge graph, wherein the heterogeneous legal knowledge graph includes a plurality of nodes and a plurality of edges, wherein the plurality of nodes represent the structured legal matter data and at least a subset of the plurality of nodes include an embedding among the plurality of embeddings as node features;
generating a graph representation by performing message passing on the heterogeneous legal knowledge graph using a graph neural network, wherein the message passing updates the node features;
generating an outcome prediction for the legal matter based on the graph representation; and
generating the output file based on the received plurality of legal documents, the output file including the outcome prediction.

2. The method of claim 1, further comprising:
identifying temporal information in the received plurality of legal documents;
identifying citations in the received plurality of legal documents;
identifying parties in the received plurality of legal documents;
standardizing the temporal information in the received plurality of legal documents to coordinated universal time;
standardizing the citations based on a citation style; and
standardizing the parties in the received legal documents based on party-role references.

3. The method of claim 2, further comprising:
identifying an authority in the plurality of legal documents based on the citations; and
constructing a citation graph, wherein the citation graph includes a plurality of citation nodes and a plurality of citation edges, wherein the authority is represented as a node among the plurality of citation nodes, the citations are represented as edges among the plurality of edges, and the plurality of citation nodes are connected by the plurality of citation edges.

4. The method of claim 1, further comprising:
identifying a plurality of text spans in the legal documents;
tokenizing the text spans based on a domain vocabulary; and
encoding the tokenized text spans using a transformer-based encoder.

5. The method of claim 4, further comprising:
pooling the encoded tokenized text spans over the plurality of text spans based on mean-pooling; and
projecting the pooled encoded tokenized text spans from a first dimension to a second dimension to generate the plurality of embeddings.

6. The method of claim 4, further comprising:
identifying clauses of the legal documents;
associating text spans to the clauses of the legal documents;
encoding the associated text spans to generate clause-level embeddings;
aggregating the clause-level embeddings;
generating section-level embeddings based on the aggregated clause-level embeddings;
aggregating the section-level embeddings; and
generating document-level embeddings based on the aggregated section-level embeddings.

7. The method of claim 1, wherein generating the outcome prediction includes applying a meta-learner to outputs of a plurality of base learners, wherein the plurality of base learners includes the graph neural network.

8. The method of claim 1, further comprising:
calibrating a probability output associated with the outcome prediction using Platt scaling, wherein the output file further includes the probability output.

9. The method of claim 1, further comprising:
modifying at least one structured attribute in the structured legal matter data;
generating a second outcome prediction based on the modified structured attribute; and
determining a counterfactual delta based on the outcome prediction and the second outcome prediction, wherein the output file further includes the counterfactual delta.

10. A non-transitory computer-readable medium storing a set of instructions for processing case-related electronic documents to generate an output file, the set of instructions comprising:
one or more instructions that, when executed by one or more processing circuitries of a device, cause the device to:
receive a plurality of legal documents as electronic files, wherein the plurality of legal documents are associated with a legal matter;
generate a structured legal matter data based on the received plurality of legal documents;
generate a plurality of embeddings for at least a portion of the legal documents using a language model;
construct a heterogeneous legal knowledge graph, wherein the heterogeneous legal knowledge graph includes a plurality of nodes and a plurality of edges, wherein the plurality of nodes represent the structured legal matter data and at least a subset of the plurality of nodes include an embedding among the plurality of embeddings as node features;
generate a graph representation by performing message passing on the heterogeneous legal knowledge graph using a graph neural network, wherein the message passing updates the node features;
generate an outcome prediction for the legal matter based on the graph representation; and
generate the output file based on the received plurality of legal documents, the output file including the outcome prediction.

11. A system for processing case-related electronic documents to generate an output file comprising:
a processing circuitry;
a memory, the memory containing instructions that, when executed by the processing circuitry, configure the system to:
receive a plurality of legal documents as electronic files, wherein the plurality of legal documents are associated with a legal matter;
generate a structured legal matter data based on the received plurality of legal documents;
generate a plurality of embeddings for at least a portion of the legal documents using a language model;
construct a heterogeneous legal knowledge graph, wherein the heterogeneous legal knowledge graph includes a plurality of nodes and a plurality of edges, wherein the plurality of nodes represent the structured legal matter data and at least a subset of the plurality of nodes include an embedding among the plurality of embeddings as node features;
generate a graph representation by performing message passing on the heterogeneous legal knowledge graph using a graph neural network, wherein the message passing updates the node features;
generate an outcome prediction for the legal matter based on the graph representation; and
generate the output file based on the received plurality of legal documents, the output file including the outcome prediction.

12. The system of claim 11, wherein the memory contains further instructions which when executed by the processing circuitry further configure the system to:
identify temporal information in the received plurality of legal documents;
identify citations in the received plurality of legal documents;
identify parties in the received plurality of legal documents;
standardize the temporal information in the received plurality of legal documents to coordinated universal time;
standardize the citations based on a citation style; and
standardize the parties in the received legal documents based on party-role references.

13. The system of claim 12, wherein the memory contains further instructions which when executed by the processing circuitry further configure the system to:
identify an authority in the plurality of legal documents based on the citations; and
construct a citation graph, wherein the citation graph includes a plurality of citation nodes and a plurality of citation edges, wherein the authority is represented as a node among the plurality of citation nodes, the citations are represented as edges among the plurality of edges, and the plurality of citation nodes are connected by the plurality of citation edges.

14. The system of claim 11, wherein the memory contains further instructions which when executed by the processing circuitry further configure the system to:
identify a plurality of text spans in the legal documents;
tokenize the text spans based on a domain vocabulary; and
encode the tokenized text spans using a transformer-based encoder.

15. The system of claim 14, wherein the memory contains further instructions which when executed by the processing circuitry further configure the system to:
pool the encoded tokenized text spans over the plurality of text spans based on mean-pooling; and
project the pooled encoded tokenized text spans from a first dimension to a second dimension to generate the plurality of embeddings.

16. The system of claim 14, wherein the memory contains further instructions which when executed by the processing circuitry further configure the system to:
identify clauses of the legal documents;
associate text spans to the clauses of the legal documents;
encode the associated text spans to generate clause-level embeddings;
aggregate the clause-level embeddings;
generate section-level embeddings based on the aggregated clause-level embeddings;
aggregate the section-level embeddings; and
generate document-level embeddings based on the aggregated section-level embeddings.

17. The system of claim 11, wherein generating the outcome prediction includes applying a meta-learner to outputs of a plurality of base learners, the plurality of base learners includes the graph neural network.

18. The system of claim 11, wherein the memory contains further instructions which when executed by the processing circuitry further configure the system to:
calibrate a probability output associated with the outcome prediction using Platt scaling, wherein the output file further includes the probability output.

19. The system of claim 11, wherein the memory contains further instructions which when executed by the processing circuitry further configure the system to:
modify at least one structured attribute in the structured legal matter data;
generate a second outcome prediction based on the modified structured attribute; and
determine a counterfactual delta based on the outcome prediction and the second outcome prediction, wherein the output file further includes the counterfactual delta.
